(19) United States
(12) Patent Application Publication
(10) Pub. No.: US 2021/0381836 A1
(43) Pub. Date: Dec. 9, 2021

(54) DEVICE NAVIGATION BASED ON CONCURRENT POSITION ESTIMATES

(71) Applicant: Microsoft Technology Licensing, LLC, Redmond, WA (US)

(72) Inventors: Raymond Kirk PRICE, Redmond, WA (US); Evan Gregory LEVINE, Seattle, WA (US)

(73) Assignee: Microsoft Technology Licensing, LLC, Redmond, WA (US)

(21) Appl. No.: 16/893,254

(22) Filed: Jun. 4, 2020

(51) Int. Cl. G01C 21/16; G02B 27/01; G02B 27/00

(52) U.S. Cl. CPC G01C 21/165; G02B 27/0093; G02B 27/0172

(57) ABSTRACT

A head-mounted display device includes a near-eye display configured to present virtual imagery. A storage machine holds instructions executable by a logic machine to concurrently output first and second position estimates via first and second navigation modalities of the device. Based on determining that the first position estimate has a higher confidence value than the second position estimate, the first position estimate is reported. As the device moves away from the first reported position, first and second subsequent position estimates are concurrently output. Based on determining that the second subsequent position estimate has a higher confidence value than the first subsequent position estimate, the second subsequent position estimate is reported. Position-specific virtual imagery is presented to a user eye via the near-eye display, the position-specific virtual imagery dynamically updating as the head-mounted display device moves.

### BACKGROUND

Many computing devices include navigation modalities useable to estimate the current position of the computing device. As examples, computing devices may navigate via global position system (GPS), visual inertial odometry (VIO), or pedestrian dead reckoning (PDR).

### BRIEF DESCRIPTION OF THE DRAWINGS

FIGS. 1A and 1B schematically illustrate position-specific virtual imagery presented via a head-mounted display device.

FIG. 2 illustrates an example method for navigation for a computing device.

FIG. 3 schematically illustrates an example head-mounted display device.

FIG. 4 illustrates reporting of position estimates concurrently output by multiple navigation modalities of a computing device.

FIG. 5 illustrates specifying a manually-defined position of a computing device.

FIG. 6 schematically illustrates an example computing system.

### DETAILED DESCRIPTION

There are many scenarios in which it may be useful for a computing device to determine its own geographic position. As one example, such information may be presented to a user—e.g., numerically in the form of latitude and longitude coordinates, or graphically as a marker on a map application. This may help the user to determine their own position (e.g., when the user has the device in their possession), or determine the device's current position (e.g., when the device is missing). As another example, the device may be configured to take certain actions or perform certain functions depending on its current position—e.g., present a notification, execute a software application, enable/disable hardware components of the device, or send a message.

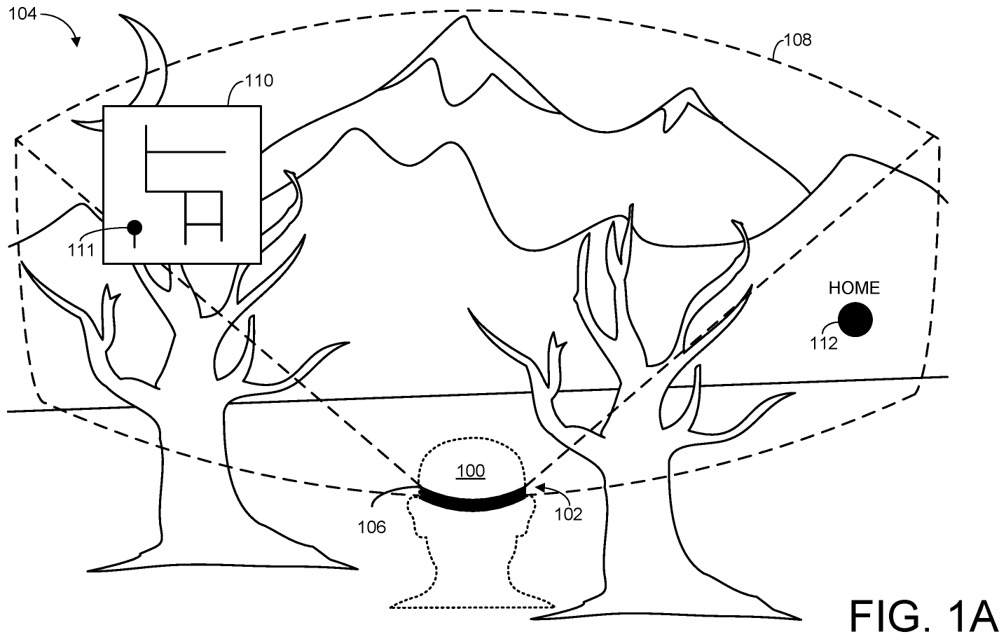

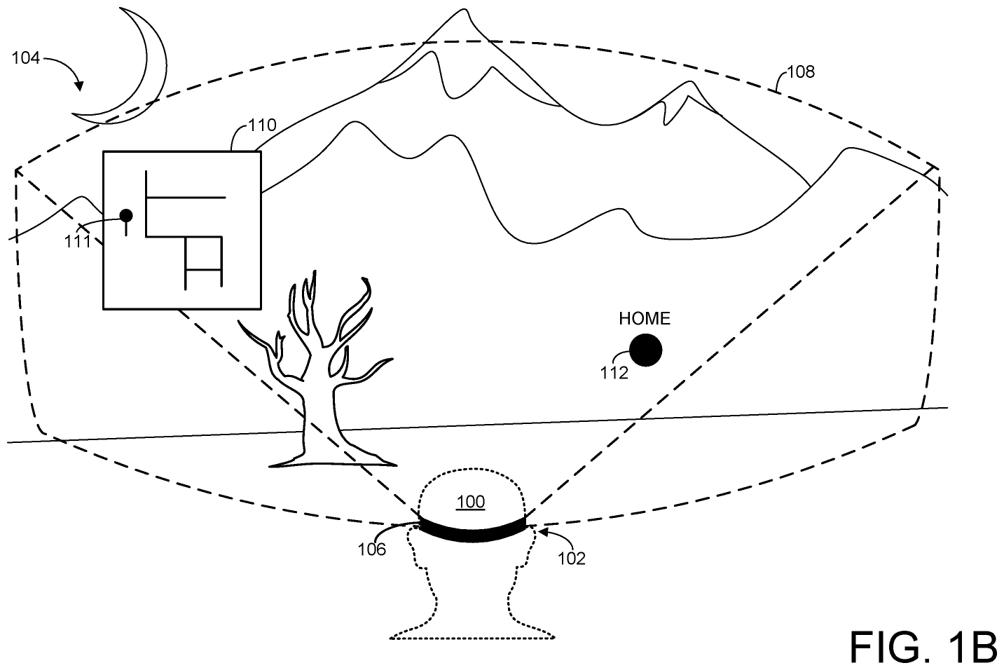

In the case of head-mounted display devices, position-specific virtual imagery may be presented to a user eye, with the position-specific virtual imagery changing or updating as the position of the device changes. This is schematically illustrated in FIG. 1A, which depicts an example user 100 using a head-mounted display device 102 in a real-world environment 104. The head-mounted display device includes a near-eye display 106 configured to present virtual imagery to a user eye. Via the near-eye display, user 100 has a field-of-view 108, in which virtual imagery presented by the near-eye display is visible to the user alongside objects in the user's real-world environment. In this manner, the head-mounted display device provides an augmented reality experience.

In FIG. 1A, head-mounted display device 102 is presenting position-specific virtual imagery 110 and 112 to the user eye via the near-eye display. Specifically, virtual imagery 110 takes the form of a map of a surrounding environment of the head-mounted display device, including a marker 111 indicating the approximate position of the device relative to the surrounding environment. Virtual imagery 112 takes the form of a persistent marker identifying a heading toward a landmark—in this case, the user's home. In other cases, other landmarks may be used—e.g., the user's car, the position of another user, a geographic feature (e.g., a nearby building, mountain, point-of-interest), or a compass direction such as magnetic or geographic North.

As the head-mounted display device moves through the environment, the position-specific virtual imagery may be updated to reflect the device's most-recently reported position. This is schematically illustrated in FIG. 1B, which again shows user 100 using head-mounted display device 102 in real-world environment 104. In FIG. 1B, however, the position of the head-mounted display device within the real-world environment has changed. Accordingly, virtual imagery 110 has been updated by changing the position of the marker 111 relative to features of the map. Similarly, virtual imagery 112 has been moved to revise the heading toward the user's home relative to the most-recently reported position of the head-mounted display device.

Various navigation techniques exist by which a device may determine its geographic position, which may enable the functionality described above. As examples, such techniques include global positioning system (GPS) navigation, visual inertial odometry (VIO), and pedestrian dead reckoning (PDR), among others. However, each of these techniques can be unreliable in various scenarios—for example, GPS navigation requires sufficient signal strength and communication with a threshold number of satellites, while VIO suffers in low-light and low-texture scenes. Thus, devices that rely on only one navigation modality may often face difficulty in accurately reporting their geographic positions.

Accordingly, the present disclosure is directed to techniques for device navigation, in which a device concurrently outputs multiple position estimates via multiple navigation modalities. Whichever of the position estimates has a highest confidence value is reported as a current reported position of the device. As the device moves and its context changes, some navigation modalities may become more reliable, while others become less reliable. Thus, at any given time, the device may report a position estimated by any of its various navigation modalities, depending on which is estimated to have the highest confidence given a current context of the device. In this manner, movements of a device may be more accurately tracked and reported, even through diverse environments in which different navigation modalities may have varying reliability at different times.

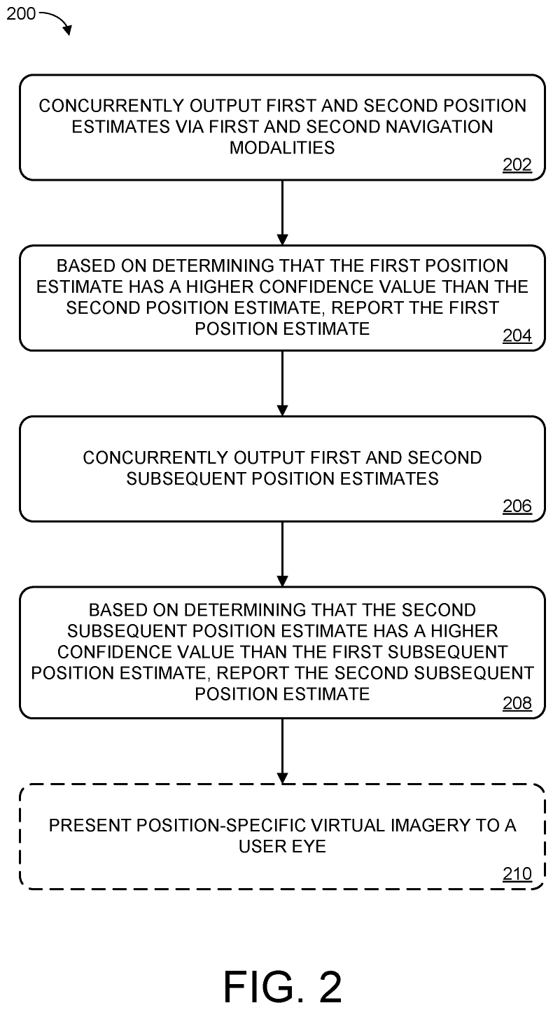

FIG. 2 illustrates an example method 200 for navigation for a computing device. Method 200 may be implemented with any suitable computing device having any suitable capabilities, hardware configuration, and form factor. While the present disclosure primarily describes navigation in the context of a head-mounted display device configured to present position-specific virtual imagery, this is not limiting. As other non-limiting examples, method 200 may be implemented via a smartphone, tablet, wearable computing device (e.g., fitness watch), vehicle, or any other portable/mobile computing device. In some examples, method 200 may be implemented via computing system 600 described below with respect to FIG. 6.

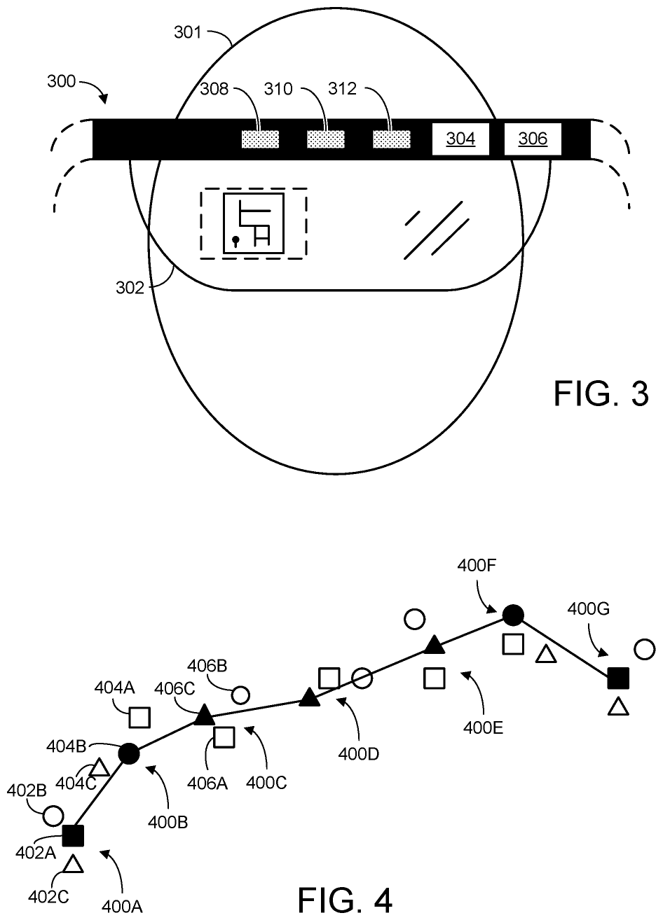

One example computing device 300 is schematically illustrated with respect to FIG. 3. In this example, the computing device takes the form of a head-mounted display device worn on a user head 301. As shown, device 300 includes a near-eye display 302 configured to present virtual imagery 303 to a user eye (the virtual imagery in this example taking the form of a map). In various implementations, head-mounted display device 300 may be configured to provide augmented and/or virtual reality experiences. Augmented reality experiences may include presenting virtual images on an at least partially transparent near-eye display, providing the illusion that the virtual images exist within the surrounding real-world environment visible through the near-eye display. Alternatively, an augmented reality experience may be provided with a fully opaque near-eye display, in which case images of the surrounding environment may be captured by a camera of the head-mounted display device and displayed on the near-eye display, with virtual images superimposed on the real-world imagery. By contrast, virtual reality experiences may be provided when virtual content displayed on an opaque near-eye display substantially replaces the user's view of the real world.

Virtual imagery presented on the near-eye display may take any suitable form, and may or may not dynamically update as the position of the head-mounted display device changes. The position-specific virtual imagery described above with respect to FIG. 1 is a non-limiting example of virtual content that may be presented to a user eye. Position-specific virtual imagery may be presented in both augmented and virtual reality settings. For example, even in fully virtual environments, a dynamically-updating map may be provided that indicates the position of the device relative to either the surrounding real-world environment, or a fictional virtual environment. Similarly, a marker indicating a heading toward a landmark may be provided for real landmarks in the real-world, or fictional virtual landmarks, regardless of whether an augmented or virtual reality experience is being provided.

Furthermore, virtual images displayed via the near-eye display may be rendered in any suitable way and by any suitable device. In some examples, virtual images may be rendered at least partially by a logic machine 304 executing instructions held by a storage machine 306 of the head-mounted display device. Additionally, or alternatively, some to all rendering of virtual images may be performed by a separate computing device communicatively coupled with the head-mounted display device. For example, virtual images may be rendered by a remote computer and transmitted to the head-mounted display device over the Internet. Additional details regarding the logic machine and storage machine will be provided below with respect to FIG. 6.

Returning to FIG. 2, at 202, method 200 includes concurrently outputting first and second position estimates via first and second navigation modalities of the computing device. However, it will be understood that a computing device as described herein may have more than two navigation modalities, and may therefore output more than two concurrent position estimates. In other words, the computing device may additionally output a third position estimate via a third navigation modality concurrently with the first and second position estimates.

As discussed above, example navigation modalities may include GPS, VIO, and PDR. The head-mounted display device 300 of FIG. 3 includes three navigation sensors 308, 310, and 312, corresponding to three different navigation modalities. For example, navigation sensor 308 may be a GPS sensor, configured to interface with a plurality of orbiting GPS satellites to estimate the current geographic position of the device. This may be expressed as an absolute position—e.g., in terms of latitude and longitude coordinates.

In contrast to the absolute position output by the GPS sensor, other navigation modalities may output position estimates that are relative to previously-reported positions. For example, navigation sensor 310 may include a camera configured to image a surrounding real-world environment. By analyzing captured images to identify image features in a surrounding environment, and evaluating how the features change as the perspective of the device changes, the device may estimate its relative position via visual odometry. In some cases, this may be combined with the output of a suitable motion sensor (e.g., an inertial measurement unit (IMU)) to implement visual inertial odometry. Notably, this will result in an estimate of the device's position relative to a previously-reported position (e.g., via GPS), rather than a novel absolute position.

Navigation sensor 312 may include a suitable collection of motion sensors (e.g., IMUs, accelerometers, magnetometers, gyroscopes) configured to estimate the direction and magnitude of a movement of the device away from a previously-reported position via PDR. Again, this will result in a position estimate that is relative to a previously-reported position, rather than a novel absolute position.

Relative position estimates, such as those output by VIO and PDR, may be less accurate than absolute position estimates, such as those output by GPS, over longer time scales. This is because each relative position estimate will likely be subject to some degree of sensor error or drift. When multiple sequential relative position estimates are output, each estimate will likely compound the sensor error/drift of the previous relative estimates, causing the reported position of the device to gradually diverge from the actual position of the device. Absolute position estimates, by contrast, are independent of previous reported positions of the device. Thus, any sensor error/drift associated with an absolute position estimate will only affect that position estimate, and will not be compounded over a sequence of estimates.

It will be understood that these navigation modalities are examples. In general, a computing device may include any number and variety of different navigation modalities configured to concurrently output different position estimates. These position estimates may be absolute estimates or relative estimates.

Concurrent output of multiple position estimates via multiple input modalities is schematically illustrated with respect to FIG. 4. As shown, at a time frame 400A, three different position estimates 402A, 402B, and 402C are output via three different navigation modalities. Each different position estimate corresponds to a different shape. In other words, position estimate 402A (the square) is output by a first navigation modality (e.g., GPS), while position estimates 402B and 402C (the circle and triangle) are output by second and third navigation modalities (e.g., VIO and PDR).

Returning to FIG. 2, at 204, method 200 includes, based on determining that the first position estimate has a higher confidence value than the second position estimate, reporting the first position estimate as a first reported position of the computing device. This is schematically illustrated in FIG. 4. Specifically, the first position estimate 402A is colored black to indicate that it has the highest confidence value, and is therefore reported as the first reported position of the computing device.

As discussed above, each of the various navigation modalities used by a device may be more or less reliable in various situations. For example, GPS navigation will typically require that the device detect at least a threshold number of GPS satellites, with a suitable signal strength, in order to output an accurate position estimate. Thus, the accuracy of a GPS position estimate may suffer when the device enters an indoor environment, or is otherwise unable to detect a suitable number of GPS satellites (e.g., due to jamming, spoofing, multipath interference, or general low-coverage).

Similarly, VIO relies on detecting features in images captured of a surrounding real-world environment. Thus, the accuracy of a VIO position estimate may decrease in low-light environments, as well as environments with relatively few unique detectable features. For example, if the device is located in an empty field, it may be difficult for the device to detect a sufficient number of features to accurately track movements of the device through the field.

With regard to PDR, the motion sensors used to implement PDR will typically exhibit some degree of drift, or other error. As time passes and the device continues to move, these errors will compound, resulting in progressively less and less accurate estimates of the device's position.

Accordingly, each position estimate output by each navigation modality of the computing device may be assigned a corresponding confidence value. These confidence values may be calculated in any suitable way, based on any suitable weighting of the various factors that contribute to the accuracy of each navigation modality. It will be understood that the specific methods used to calculate the confidence values, as well as the specific form each confidence value takes, will vary from implementation to implementation and from one navigation modality to another.

For instance, as discussed above, a sequence of absolute position estimates will generally be less susceptible to sensor error/drift as compared to a sequence of relative position estimates. Thus, when determining confidence values for a particular position estimate, the nature of the navigation modality used to output the estimate (i.e., absolute vs relative) may be considered as an input. As such, absolute position estimates (e.g., GPS) may generally have a higher confidence than relative position estimates (e.g., VIO, PDR), especially in the case where a previously-reported position of the device was output by a relative navigation modality.

Regardless, each time the device concurrently outputs position estimates via the two or more navigation modalities, the position estimate with the highest confidence value will be reported as the reported position of the computing device. Notably, “reporting” a position need not require the position to be displayed or otherwise indicated to a user of the computing device. Rather, a “reported” position is a computing device's internal reference for its current position, as of the current time. In other words, any location-specific functionality of the computing device may treat a most-recently reported position as the actual position of the computing device. For example, any software applications of the computing device requesting the device's current position (e.g., via a position API) may be provided with the most-recently reported position, regardless of whether this position is ever indicated visually or otherwise to the user, though many implementations will provide a visual representation.

Returning to FIG. 2, at 206, method 200 includes concurrently outputting first and second subsequent position estimates via the first and second navigation modalities of the computing device, as the computing device moves away from the first reported position. Once again, the computing device may in some cases include more than two navigation modalities, and may therefore concurrently output more than two subsequent position estimates. This is also schematically illustrated in FIG. 4. As shown, at each of a plurality of successive time frames 400B-400G, the device concurrently outputs new position estimates via the various navigation modalities of the computing device. The successive time frames may occur at any suitable frequency—e.g., 1 frame-per-second (fps), 5 fps, 10 fps, 30 fps, 60 fps. In some examples, the successive time frames may not occur with any fixed frequency. Rather, the navigation modalities may concurrently output position estimates any time one or more software applications of the device request the device's current position.

Returning to FIG. 2, at 208, method 200 includes reporting a second subsequent position estimate, output via the second navigation modality, as a second reported position of the computing device. This may be done based on determining that the confidence value of the second subsequent position estimate is higher than the confidence value of a first subsequent position estimate, output via the first navigation modality. This is also schematically illustrated in FIG. 4. As shown, at time frame 400B, the second subsequent position estimate 404B is colored black to indicate that it is reported as the second reported position of the computing device, rather than the first subsequent position estimate 404A.

Continuing with FIG. 4, at time frame 400C, a third subsequent position estimate 406C reported via a third navigation modality is reported as a third reported position of the computing device. In general, at any particular time frame, each navigation modality of the computing device may output a different position estimate of the computing device. Whichever of these position estimates has the highest confidence value may be reported as a most-recently reported position of the computing device.

As discussed above, there are any number of factors that may affect the accuracy of any particular position estimate. Thus, as the computing device moves and the conditions in the surrounding environment of the computing device change, some navigation modalities may become more accurate, while others may become less accurate. This may contribute to the behavior illustrated in FIG. 4, in which the first navigation modality has the highest confidence at time frame 400A, while the second navigation modality has the highest confidence at time frame 400B.

In one example scenario, the first navigation modality may be GPS navigation. As the device moves between the first and second reported positions, a number of GPS satellites available to the device may decrease, therefore lowering the confidence value of the first subsequent position estimate. This may occur when, for example, the computing device moves from an outdoor environment to an indoor environment between the first and second reported positions.

In another example scenario, the first navigation modality may be VIO. As the device moves between the first and second reported positions, an ambient light level in an environment of the device may decrease, therefore lowering the confidence value of the first subsequent position estimate. Additionally, or alternatively, the confidence value of the first subsequent position estimate may decrease when a level of texture in a scene visible to a camera of the device decreases between the first and second reported positions.

In another example scenario, the first navigation modality may be PDR. As discussed above, sensors used to implement PDR will typically exhibit some degree of error, and these errors will compound over time. Thus, the confidence value of a position estimate output via PDR may be inversely proportional to an elapsed time since an alternative navigation modality (e.g., one configured to output absolute position estimates) was available. In other words, as time passes after the first position is reported, the confidence value of position estimates output via PDR may decrease to below the confidence values corresponding to other position estimates output via other navigation modalities.

Returning again to FIG. 2, at 210, method 200 includes presenting position-specific virtual imagery to the user eye via the near-eye display, the position-specific virtual imagery dynamically updating as the head-mounted display device moves from the first reported position to the second reported position. Step 210 is shown in dashed lines to indicate that presentation and updating of position-specific virtual imagery may be ongoing throughout the entirety of method 200. As discussed above, FIGS. 1A and 1B depict non-limiting examples of position-specific virtual imagery. For instance, FIG. 1A may depict the computing device at the first reported position, while FIG. 1B depicts the computing device at the second reported position.

The present disclosure has thus far primarily considered position estimates in terms of confidence values, calculated based on various factors that may affect accuracy (e.g., GPS coverage, light-level). However, other factors may additionally or alternatively be considered. For example, some navigation modalities may have a greater impact on device battery life than others. As one example, VIO may consume more battery charge than GPS or PDR. Accordingly, when the first navigation modality is VIO, the remaining battery level of the device may decrease below a threshold (e.g., 20%) before the second position is reported. Accordingly, in some examples, VIO (and/or other battery-intensive navigation modalities) may be disabled when the device battery level drops below a threshold. Thus, that navigation modality may not output a position estimate at the next time frame. As such, the second subsequent position estimate output by a second (e.g., less battery-intensive) navigation modality may be reported.

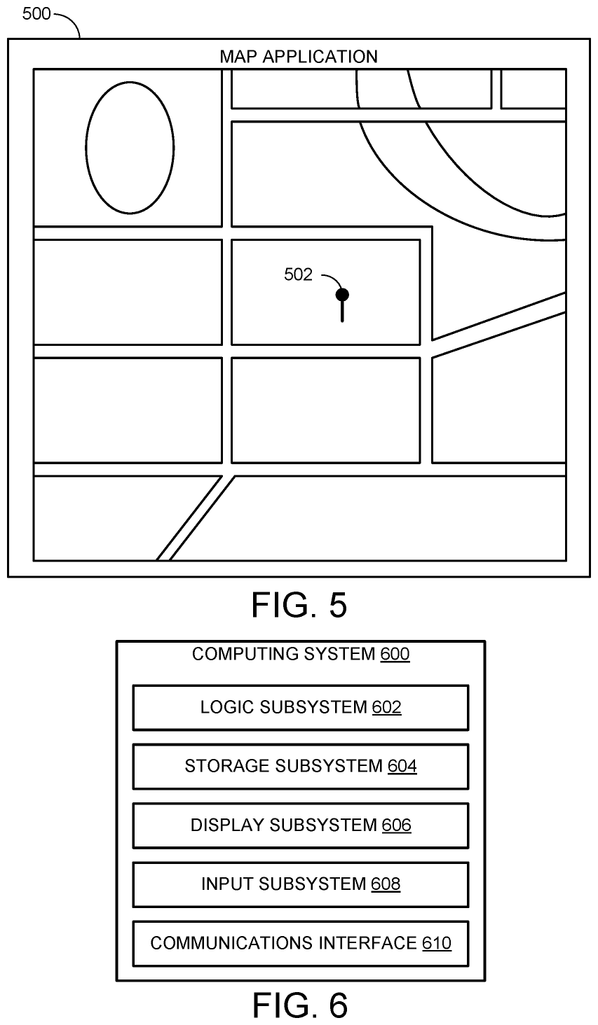

Furthermore, in some cases, the device may receive a user input specifying a manually-defined position of the device. This manually-defined position may then be reported as a most-recently reported position of the device. This user input may take any suitable form. As one example, the user may manually enter numerical coordinates. The user may specify a particular heading—e.g., North, or the direction to a particular fixed landmark. As another example, the user may place a marker defining the manually-defined position within a map application. This is illustrated in FIG. 5, in which a marker 502 is placed within a map application 500.

The methods and processes described herein may be tied to a computing system of one or more computing devices. In particular, such methods and processes may be implemented as an executable computer-application program, a network-accessible computing service, an application-programming interface (API), a library, or a combination of the above and/or other compute resources.

FIG. 6 schematically shows a simplified representation of a computing system 600 configured to provide any to all of the compute functionality described herein. Computing system 600 may take the form of one or more personal computers, network-accessible server computers, tablet computers, home-entertainment computers, gaming devices, mobile computing devices, mobile communication devices (e.g., smart phone), virtual/augmented/mixed reality computing devices, wearable computing devices, Internet of Things (IoT) devices, embedded computing devices, and/or other computing devices.

Computing system 600 includes a logic subsystem 602 and a storage subsystem 604. Computing system 600 may optionally include a display subsystem 606, input subsystem 608, communication subsystem 610, and/or other subsystems not shown in FIG. 6.

Logic subsystem 602 includes one or more physical devices configured to execute instructions. For example, the logic subsystem may be configured to execute instructions that are part of one or more applications, services, or other logical constructs. The logic subsystem may include one or more hardware processors configured to execute software instructions. Additionally, or alternatively, the logic subsystem may include one or more hardware or firmware devices configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. Aspects of the logic subsystem may be virtualized and executed by remotely-accessible, networked computing devices configured in a cloud-computing configuration.

Storage subsystem 604 includes one or more physical devices configured to temporarily and/or permanently hold computer information such as data and instructions executable by the logic subsystem. When the storage subsystem includes two or more devices, the devices may be collocated and/or remotely located. Storage subsystem 604 may include volatile, nonvolatile, dynamic, static, read/write, read-only, random-access, sequential-access, location-addressable, file-addressable, and/or content-addressable devices. Storage subsystem 604 may include removable and/or built-in devices. When the logic subsystem executes instructions, the state of storage subsystem 604 may be transformed—e.g., to hold different data.

Aspects of logic subsystem 602 and storage subsystem 604 may be integrated together into one or more hardware-logic components. Such hardware-logic components may include program- and application-specific integrated circuits (PASIC/ASICs), program- and application-specific standard products (PSSP/ASSPs), system-on-a-chip (SOC), and complex programmable logic devices (CPLDs), for example.

The logic subsystem and the storage subsystem may cooperate to instantiate one or more logic machines. As used herein, the term “machine” is used to collectively refer to the combination of hardware, firmware, software, instructions, and/or any other components cooperating to provide computer functionality. In other words, “machines” are never abstract ideas and always have a tangible form. A machine may be instantiated by a single computing device, or a machine may include two or more sub-components instantiated by two or more different computing devices. In some implementations a machine includes a local component (e.g., software application executed by a computer processor) cooperating with a remote component (e.g., cloud computing service provided by a network of server computers). The software and/or other instructions that give a particular machine its functionality may optionally be saved as one or more unexecuted modules on one or more suitable storage devices.

When included, display subsystem 606 may be used to present a visual representation of data held by storage subsystem 604. This visual representation may take the form of a graphical user interface (GUI). Display subsystem 606 may include one or more display devices utilizing virtually any type of technology. In some implementations, display subsystem may include one or more virtual-, augmented-, or mixed reality displays.

When included, input subsystem 608 may comprise or interface with one or more input devices. An input device may include a sensor device or a user input device. Examples of user input devices include a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition.

When included, communication subsystem 610 may be configured to communicatively couple computing system 600 with one or more other computing devices. Communication subsystem 610 may include wired and/or wireless communication devices compatible with one or more different communication protocols. The communication subsystem may be configured for communication via personal-, local- and/or wide-area networks.

This disclosure is presented by way of example and with reference to the associated drawing figures. Components, process steps, and other elements that may be substantially the same in one or more of the figures are identified coordinately and are described with minimal repetition. It will be noted, however, that elements identified coordinately may also differ to some degree. It will be further noted that some figures may be schematic and not drawn to scale. The various drawing scales, aspect ratios, and numbers of components shown in the figures may be purposely distorted to make certain features or relationships easier to see.

In an example, a head-mounted display device comprises: a near-eye display configured to present virtual imagery to a user eye; a logic machine; and a storage machine holding instructions executable by the logic machine to: concurrently output first and second position estimates via first and second navigation modalities of the head-mounted display device; based on determining that the first position estimate, output via the first navigation modality, has a higher confidence value than the second position estimate, report the first position estimate as a first reported position of the head-mounted display device; as the head-mounted display device moves away from the first reported position, concurrently output first and second subsequent position estimates via the first and second navigation modalities; based on determining that the second subsequent position estimate, output via the second navigation modality, has a higher confidence value than the first subsequent position estimate, report the second subsequent position estimate as a second reported position of the head-mounted display device; and present position-specific virtual imagery to the user eye via the near-eye display, the position-specific virtual imagery dynamically updating as the head-mounted display device moves from the first reported position to the second reported position. In this example or any other example, the instructions are further executable to output a third position estimate via a third navigation modality concurrently with the first and second position estimates. In this example or any other example, the instructions are further executable to output a third subsequent position estimate via the third navigation modality, and report the third subsequent position estimate as a third reported position of the head-mounted display device. In this example or any other example, the first and second navigation modalities include two of i) global positioning system (GPS) navigation, ii) visual inertial odometry (VIO), and iii) pedestrian dead reckoning (PDR). In this example or any other example, the first navigation modality is global positioning system (GPS) navigation, and a confidence of a GPS-reported position decreases as the head-mounted display device moves between the first and second reported positions. In this example or any other example, the first navigation modality is global positioning system (GPS) navigation, and the head-mounted display device moves from an outdoor environment to an indoor environment between the first and second reported positions. In this example or any other example, the first navigation modality is visual inertial odometry (VIO), and an ambient light level in an environment of the head-mounted display device decreases between the first and second reported positions. In this example or any other example, the first navigation modality is visual inertial odometry (VIO), and a level of texture in a scene visible to a camera of the head-mounted display device decreases between the first and second reported positions. In this example or any other example, the first navigation modality is visual inertial odometry (VIO), and the second subsequent position estimate is reported further based on a battery level of the head-mounted display device decreasing below a threshold. In this example or any other example, the first navigation modality is pedestrian dead reckoning (PDR), and the confidence value of the first position estimate is inversely proportional to an elapsed time since an alternate navigation modality was available. In this example or any other example, the instructions are further executable to receive a user input specifying a manually-defined position of the head-mounted display device, and reporting the manually-defined position as a third reported position of the head-mounted display device. In this example or any other example, the user input comprises placing a marker defining the manually-defined position within a map application. In this example or any other example, the position-specific virtual imagery includes a persistent marker identifying a heading toward a landmark relative to a most-recently reported position of the head-mounted display device. In this example or any other example, the position-specific virtual imagery includes a map of a surrounding environment of the head-mounted display device. In this example or any other example, the first position estimate is a relative position estimate, and the second subsequent position estimate is an absolute position estimate.

In an example, a method for navigation for a head-mounted display device comprises: concurrently outputting first and second position estimates via first and second navigation modalities of the head-mounted display device; based on determining that the first position estimate, output via the first navigation modality, has a higher confidence value than the second position estimate, reporting the first position estimate as a first reported position of the head-mounted display device; as the head-mounted display device moves away from the first reported position, concurrently outputting first and second subsequent position estimates via the first and second navigation modalities; based on determining that the second subsequent position estimate, output via the second navigation modality, has a higher confidence value than the first subsequent position estimate, reporting the second subsequent position estimate as a second reported position of the head-mounted display device; and presenting position-specific virtual imagery to a user eye via a near-eye display of the head-mounted display device, the position-specific virtual imagery dynamically updating as the head-mounted display device moves from the first reported position to the second reported position. In this example or any other example, the method further comprises outputting a third position estimate via a third navigation modality concurrently with the first and second position estimates. In this example or any other example, the first and second navigation modalities include two of i) global positioning system (GPS) navigation, ii) visual inertial odometry (VIO), and iii) pedestrian dead reckoning (PDR). In this example or any other example, the first navigation modality is global positioning system (GPS) navigation, and where the head-mounted display device moves from an outdoor environment to an indoor environment between the first and second reported positions.

In an example, a computing device comprises: a logic machine; and a storage machine holding instructions executable by the logic machine to: concurrently output first, second, and third position estimates via i) global positioning system (GPS), ii) visual inertial odometry (VIO), and iii) pedestrian dead reckoning (PDR) navigation modalities of the computing device; based on determining that the first position estimate, output via the GPS navigation modality, has a higher confidence value than the second position estimate and the third position estimate, report the first position estimate as a first reported position of the head-mounted display device; as the computing device moves away from the first reported position, concurrently output first, second, and third subsequent position estimates via the GPS, VIO, and PDR navigation modalities; based on determining that the second subsequent position estimate, output via the VIO navigation modality, has a higher confidence value than the first subsequent position estimate and the third subsequent position estimate, report the second subsequent position estimate as a second reported position of the computing device; as the computing device moves away from the second reported position, concurrently output fourth, fifth, and sixth subsequent position estimates via the GPS, VIO, and PDR navigation modalities; and based on determining that the sixth subsequent position estimate, output via the PDR navigation modality, has a higher confidence value than the fourth subsequent position estimate and the fifth subsequent position estimate, report the sixth subsequent position estimate as a third reported position of the computing device.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

1. A head-mounted display device, comprising:
a near-eye display configured to present virtual imagery to a user eye;
a logic machine; and
a storage machine holding instructions executable by the logic machine to:
concurrently output first and second position estimates via first and second navigation modalities of the head-mounted display device;
based on determining that the first position estimate, output via the first navigation modality, has a higher confidence value than the second position estimate, report the first position estimate as a first reported position of the head-mounted display device;
as the head-mounted display device moves away from the first reported position, concurrently output first and second subsequent position estimates via the first and second navigation modalities;
based on determining that the second subsequent position estimate, output via the second navigation modality, has a higher confidence value than the first subsequent position estimate, report the second subsequent position estimate as a second reported position of the head-mounted display device; and
present position-specific virtual imagery to the user eye via the near-eye display, the position-specific virtual imagery dynamically updating as the head-mounted display device moves from the first reported position to the second reported position.

2. The head-mounted display device of claim 1, where the instructions are further executable to output a third position estimate via a third navigation modality concurrently with the first and second position estimates.

3. The head-mounted display device of claim 2, where the instructions are further executable to output a third subsequent position estimate via the third navigation modality, and report the third subsequent position estimate as a third reported position of the head-mounted display device.

4. The head-mounted display device of claim 1, where the first and second navigation modalities include two of i) global positioning system (GPS) navigation, ii) visual inertial odometry (VIO), and iii) pedestrian dead reckoning (PDR).

5. The head-mounted display device of claim 1, where the first navigation modality is global positioning system (GPS) navigation, and a confidence of a GPS-reported position decreases as the head-mounted display device moves between the first and second reported positions.

6. The head-mounted display device of claim 1, where the first navigation modality is global positioning system (GPS) navigation, and where the head-mounted display device moves from an outdoor environment to an indoor environment between the first and second reported positions.

7. The head-mounted display device of claim 1, where the first navigation modality is visual inertial odometry (VIO), and where an ambient light level in an environment of the head-mounted display device decreases between the first and second reported positions.

8. The head-mounted display device of claim 1, where the first navigation modality is visual inertial odometry (VIO), and where a level of texture in a scene visible to a camera of the head-mounted display device decreases between the first and second reported positions.

9. The head-mounted display device of claim 1, where the first navigation modality is visual inertial odometry (VIO), and where the second subsequent position estimate is reported further based on a battery level of the head-mounted display device decreasing below a threshold.

10. The head-mounted display device of claim 1, where the first navigation modality is pedestrian dead reckoning (PDR), and where the confidence value of the first position estimate is inversely proportional to an elapsed time since an alternate navigation modality was available.

11. The head-mounted display device of claim 1, where the instructions are further executable to receive a user input specifying a manually-defined position of the head-mounted display device, and reporting the manually-defined position as a third reported position of the head-mounted display device.

12. The head-mounted display device of claim 11, where the user input comprises placing a marker defining the manually-defined position within a map application.

13. The head-mounted display device of claim 1, where the position-specific virtual imagery includes a persistent marker identifying a heading toward a landmark relative to a most-recently reported position of the head-mounted display device.

14. The head-mounted display device of claim 1, where the position-specific virtual imagery includes a map of a surrounding environment of the head-mounted display device.

15. The head-mounted display device of claim 1, where the first position estimate is a relative position estimate, and the second subsequent position estimate is an absolute position estimate.

16. A method for navigation for a head-mounted display device, the method comprising:
concurrently outputting first and second position estimates via first and second navigation modalities of the head-mounted display device;
based on determining that the first position estimate, output via the first navigation modality, has a higher confidence value than the second position estimate, reporting the first position estimate as a first reported position of the head-mounted display device;
as the head-mounted display device moves away from the first reported position, concurrently outputting first and second subsequent position estimates via the first and second navigation modalities;
based on determining that the second subsequent position estimate, output via the second navigation modality, has a higher confidence value than the first subsequent position estimate, reporting the second subsequent position estimate as a second reported position of the head-mounted display device; and
presenting position-specific virtual imagery to a user eye via a near-eye display of the head-mounted display device, the position-specific virtual imagery dynamically updating as the head-mounted display device moves from the first reported position to the second reported position.

17. The method of claim 16, further comprising outputting a third position estimate via a third navigation modality concurrently with the first and second position estimates.

18. The method of claim 16, where the first and second navigation modalities include two of i) global positioning system (GPS) navigation, ii) visual inertial odometry (VIO), and iii) pedestrian dead reckoning (PDR).

19. The method of claim 16, where the first navigation modality is global positioning system (GPS) navigation, and where the head-mounted display device moves from an outdoor environment to an indoor environment between the first and second reported positions.

20. A computing device, comprising:
a logic machine; and
a storage machine holding instructions executable by the logic machine to:
concurrently output first, second, and third position estimates via i) global positioning system (GPS), ii) visual inertial odometry (VIO), and iii) pedestrian dead reckoning (PDR) navigation modalities of the computing device;
based on determining that the first position estimate, output via the GPS navigation modality, has a higher confidence value than the second position estimate and the third position estimate, report the first position estimate as a first reported position of the head-mounted display device;
as the computing device moves away from the first reported position, concurrently output first, second, and third subsequent position estimates via the GPS, VIO, and PDR navigation modalities;
based on determining that the second subsequent position estimate, output via the VIO navigation modality, has a higher confidence value than the first subsequent position estimate and the third subsequent position estimate, report the second subsequent position estimate as a second reported position of the computing device;
as the computing device moves away from the second reported position, concurrently output fourth, fifth, and sixth subsequent position estimates via the GPS, VIO, and PDR navigation modalities; and
based on determining that the sixth subsequent position estimate, output via the PDR navigation modality, has a higher confidence value than the fourth subsequent position estimate and the fifth subsequent position estimate, report the sixth subsequent position estimate as a third reported position of the computing device.
